(19) United States
(12) Patent Application Publication
(10) Pub. No.: US 2007/0021304 A1
(43) Pub. Date: Jan. 25, 2007

(54) Non-salt glyphosate herbicide composition and method for preparing the same

(75) Inventors: Kang-Chi Lin, Taichung City (TW); Jeff Liu, Taichung City (TW); Chen-Ping Weng, Taichung City (TW)

Correspondence Address: BACON & THOMAS, PLLC, 625 SLATERS LANE, FOURTH FLOOR, ALEXANDRIA, VA, 22314, US

(73) Assignee: Sinon Corporation, Taichung City (TW)

(21) Appl. No.: 11/244,281

(22) Filed: Oct. 6, 2005

(30) Foreign Application Priority Data
Jul. 25, 2005 (TW) 94125088

(51) Int. Cl. A01N 57/18; A01N 25/12

(52) U.S. Cl. 504/127; 504/206; 504/367

(57) ABSTRACT

The invention discloses a dried glyphosate granule herbicide composition, comprising 50˜950 g/kg glyphosate, 5˜950 g/kg non-inorganic salt extender, and 0.5˜150 g/kg organo-silicon surfactant. The herbicide according to the present invention uses glyphosate as the active ingredient without turning it into salt derivatives, hence reducing the cost of preparation. The present invention also provides a method for preparing the glyphosate herbicide disclosed.

### FIELD OF THE INVENTION

The present invention discloses a glyphosate herbicide composition and method for preparing the same; more particularly, an herbicide composition in dry granular formulation is prepared from non-salt derivatives of glyphosate added with non-inorganic salt extender and organo-silicon surfactant.

### BACKGROUND OF THE INVENTION

Glyphosate is a non-selective systemic herbicide widely applied in post-seeding weed control. After applying it for a period of time, glyphosate is absorbed by leafs and non-ligneous stems and transferred to the interior of the plant. It is very effective against deep-rooted perennial weeds and evergreen, annual or biannual cyperaceae, gramineae and broadleaf weed.

Glyphosate has low water solubility at approximately 10.5 g/L (pH 1.9, 20° C.). Thus the market glyphosate herbicide is commonly transformed into salt derivatives and then prepared in liquid formulation. Commonly known salt derivatives of glyphosate include glyphosate ammonium salt, glyphosate isopropylammonium salt, glyphosate sodium salt, and glyphosate trimesium salt, etc. The glyphosate product in liquid formulation is diluted with water before spraying; product in the dry water-soluble granule or water dispersible granule formulation is added with water to let the granules be dissolved or dispersed in water before use.

Glyphosate's weed control effect and its manufacturing process have been disclosed in U.S. Pat. No. 3,799,758. The manufacturing process for its salt derivatives has been disclosed in U.S. Pat No. 4,405,531. Moreover, other published methods for glyphosate herbicide preparation are disclosed in EPO Publication No. EP0378985 and U.S. Pat. No. 5,872,078, which respectively relates to admixing glyphosate salt acquired by adding bases to glyphosate acid. Ethoxylated tallow amine containing 15˜18 moles of ethylene oxide serving as an adjuvant then mixes with inorganic extender, such as ammonium sulfate, potassium sulfate, potassium chloride, sodium sulfate or urea, to extrude the mixture to obtain the composition.

To increase the water solubility of glyphosate, the prior arts for glyphosate herbicide preparations just described commonly turn glyphosate into salt derivatives and then prepares it into water-soluble formulation. Prior arts also use primarily inorganic salts as extender. Long-term and massive use of inorganic salts, for example, ammonium sulfate, will make the salts dissociate into ammonia and sulfate upon contacting the moisture in the soil. The ammonia will be absorbed by the plant, while the sulfate left in the soil and gradually causing the acidic caking of soil, hence lower the pH of soil. Potassium sulfate and potassium chloride also produce salt, sulfate and chlorine ion after application, and they will gradually cause the acidification of soil as well. Urea produces nitrate in the soil after application; its long-term use also lowers the pH of soil. Sodium sulfate is a main ingredient in saline soil; it will be hydrolyzed in soil and exhibit alkalinity to gradually raise the pH of soil to as high as 8.5. If the soil contained large amount of water-soluble salts, such as Na₂SO₄, NaCl, MgSO₄, CaSO₄, and MgCl₂, it would become saline soil when the total content of water-soluble salts reached 0.2% of dry soil amount, and it would be suitable for the growth of only a few saline adaptive plants. Therefore, the prior arts for herbicide preparation have the drawbacks of high cost, complex process, and easily causing the acidification or salination of soil with the use of inorganic extender. For these reasons, there is a need for developing an environment friendly glyphosate herbicide with low cost of development and simplified preparation steps.

### SUMMARY OF THE INVENTION

The present invention provides a herbicide composition, comprising 50˜950 g/kg glyphosate, 5˜950 g/kg non-inorganic salt extender, and 0.5˜150 g/kg organo-silicon surfactant.

The content of said glyphosate is preferably 100˜920 g/kg.

The content of said non-inorganic salt extender is preferably 10˜946 g/kg. Said extender includes, but is not limited to, lactose, sucrose, glucose, dextrin, cyclodextrin, maltodextrin and combinations thereof.

The content of said organo-silicon surfactant is preferably 1˜100 g/kg. Said organo-silicon surfactant includes, but is not limited to, polyalkene oxide modified heptamethyl trisiloxane compound and combinations thereof.

An embodiment of the herbicide composition according to the present invention relates to a kind of glyphosate herbicide composition in the form of dried water-dispersible granule. The composition comprises at least glyphosate, extender, and organo-silicon surfactant, and may be added with one or more synergistic herbicides. Most preferably, the composition is prepared directly with dry glyphosate powders in its original form to reduce the costs incurred from the addition of bases to form salt derivatives. If the composition were added with two or more synergistic herbicides, water-dispersible granule preparation would still be preferred.

Another important feature of the present invention is the use of non-inorganic-salt-water-soluble extender to mitigate the problem of soil acidification or salination caused by prolonged use of inorganic extender.

If necessary, the glyphosate herbicide of the present invention can be further mixed with other herbicides to enhance the weed control effect and expand its applications. The present herbicide can also be mixed with insecticide, dustmite miticide, nematicide, fungicide, or plant growth regulator at the same time.

Another object of the present invention is to provide a method for preparing the composition disclosed herein, and the method comprises the steps of: (a) mixing glyphosate, extender, and organo-silicon surfactant to form a pre-mixture; (b) milling said pre-mixture into finer powders with at least 50% of powders having grain diameter of less than 0.075 mm; (c) adding 30˜200 g/kg of water to said finer powders and mixing it uniformly; (d) extruding the mixture resulted in step (c) to obtain granular herbicide composition; and (e) drying the herbicide composition resulted in step (d) to remove moisture in the granules.

The preparation of herbicide composition according to the present invention can employ the methods of fluid bed, extrusion, pan, spray dry, or flaking roll (to make into flakes), or the like.

The composition of the present invention is prepared by adding extender and organo-silicon surfactant as extrusion aid to dried crystalline glyphosate in its original form and then carrying out the granulation procedure. Mixing organo-silicon surfactant in the formulation of the composition can increase the lubricity of material in the extrusion process and improve the permeability of active ingredient glyphosate, thereby enhance the weed control performance of herbicide.

Some synergistic herbicides or their salts can be further mixed into the composition of the present invention in the preparation process. Said synergistic herbicides include: 2,4-D (2,4-dichlorophenoxy acetic acid), 2,4,5-T (2,4,5-trichloroacetic acid), 2,3,6-TBA (2,3,6-trichlorobenzoic acid), amidosulfuron(1-(4,6-dimethoxypyrimidin-2-yl)-3-mesyl(methyl)sulfamoyl urea), acifluorfen-sodium, bilanafos(4-[hydroxy(methyl)phosphinoyl]-L-homoalanyl-L-alanyl-L-alanine), chloramben(3-amino-2,5-dichlorobenzoic acid), dalapon(2,2-dichloro-propionic acid), dicamba(3,6-dichloro-O-anisic acid), dichlorprop(2,4-dichlorophenoxypropionic acid), endothal(7-oxabicyclo(2.2.1)heptane-2,3-dicarboxylic acid, glufosinate(ammonium 4-[hydroxy(methyl)phosphinoyl]-DL-homoalaninate; ammonium DL-homoalanin-4-yl(methyl)phosphinate), mecoprop((RS)-2-(4-chloro-o-tolyloxy)propionic acid), MCPA ((4-chloro-2-methylphenoxy) acetic acid, MCPB ((ethyl 4-(4-chloro-2-methylphenoxy)butanoate), picloram(4-amino-3,5,6-trichloro-2-pyridinecarboxylic acid), imazaquin((RS)-2-(4-isopropyl-4-methyl-5-oxo-2-imidazolin-2-yl)quinoline-3-carboxylic acid).

The composition of the present invention contains suitable extender and organo-silicon surfactant. Because glyphosate has low water solubility with dry and unsmooth appearance, it's difficult for it to be squeezed out and molded in the extrusion process, and organo-silicon surfactant is required to be added to increase its lubricity in the extrusion process and enhance its weed control performance.

### DETAILED DESCRIPTION OF THE INVENTION

The present invention provides a herbicide composition, comprising 50˜950 g/kg glyphosate, 5˜950 g/kg non-inorganic salt extender, and 0.5˜150 g/kg organo-silicon surfactant. In the herbicide composition, the glyphosate is not a salt derivative and its content is preferably 100˜920 g/kg; the content of organo-surfactant is preferably 1˜100 g/kg; the content of the extender is preferably 10˜946 g/kg; the organo-silicon surfactant, such as polysiloxane, is used to enhance the weed control performance of glyphosate and increase its lubricity and discharge during extrusion. Preferably, the polysiloxane contains more than 80% of polyalkene oxide modified heptamethyl trisiloxane. In addition, if necessary, the composition of the present invention can further contain extrusion aid, including monosodium L-glutamate, glutamic acid, glutamine, or combinations thereof.

In a preferred embodiment of the present invention, the method for preparing the herbicide composition comprises the steps of: (a) adding proper amount of glyphosate, extender, and extrusion aid (organo-silicon surfactant) into a ribbon blender or an instrument having equal functions to mix the ingredients to form a pre-mixture of specific concentration; (b) putting the pre-mixture into a jet miller or an equipment of equal functions under dry air pressure of 6˜8 kg/cm² to let the particles of pre-mixture collide with each other and be crushed into finer powders; after this step, the grain size of pre-mixture powders becomes smaller and the specific surface area of powders increases, therefore enhance the water solubility and dispersion rate of finished product. At least 50% of the powders have grain diameter of less than 0.075 mm; preferably 90% of the powders have grain diameter of less than 0.075 mm; (c) adding a proper amount of water to the resulted finer powders and undergoing kneading in a kneader to obtain an uniform mixture; the amount of water added is 30˜200 g/kg, preferably 50˜140 g/kg; (d) passing the mixture obtained in step (c) through an extruder to obtain granules with cylindrical shape and granule size in the range of 0.1˜5.00 mm and granule length in the range of 0.5˜15 mm, preferably size in the range of 0.3˜3.0 mm and length in the range of 1˜10 mm (depending on the size of screen mesh used in the extrusion process); (e) after extrusion is achieved, drying the granules in fluid bed dryer, oven, or a device having equal functions under 40˜70° C. to remove moisture and form dried granules as finished product. The moisture content of the finished product is 0.1˜60 g/kg, preferably 1˜35 g/kg; and (f) after drying, sieving the resulting granules and returning granules not meeting the aforementioned specifications back to the granulation process.

The method for preparing glyphosate herbicide composition and test results are depicted in examples below. These examples are meant to illustrate the advantages of the present invention, and should not be construed as a limitation on the actual applications of the present invention.

### EXAMPLES

### Example 1

### Preparing Water-Dispersible Granules Containing Active Ingredient of 100 g/kg Glyphosate

Pre-mixture of water-dispersible granules containing 100 g/kg
glyphosate

| Composition | Grams |
|---|---|
| Glyphosate dry powder (95%) | 105.3 |
| Silwet ® 408 | 1.0 |
| Sucrose | 893.7 |

Silwet ® 408 is an adjuvant

Mix the ingredients by the ratios described above in a ribbon blender or an instrument having equal functions to obtain a pre-mixture containing 100 g/kg glyphosate.

Subject the pre-mixture into a jet miller or an equipment having equal functions to crush the pre-mixture into finer powders with 90% of powders having grain diameter of less than 0.075 mm.

Put the finer powders into another ribbon blender; spray water onto the powders until the moisture content in the powders reaches 40˜100 g/kg and then subject the mixture to a kneader to obtain a uniform mixture.

Pass the uniform mixture through an extruder installed with 1.0 mm mesh (different mesh sizes may be used based on actual needs) to obtain granules with cylindrical shape and granule diameter in the range of 0.8˜1.2 mm and length in the range of 1˜10 mm.

After extrusion is achieved, dry the granules in a fluid-bed dryer (or a device having equal functions) under 40˜70° C. to form dried granules as finished product; the moisture content of the finished product is 1˜35 g/kg. After drying, sieve the resulted granules and return granules not meeting the specifications back to the granulation process.

According to the method described above, water-dispersible granules containing active ingredient of 100 g/kg glyphosate are obtained.

### Example 2

### Preparing Water-Dispersible Granules Containing Active Ingredient of 410 g/kg Glyphosate

Pre-mixture of water-dispersible granules containing 410 g/kg
glyphosate

| Composition | Grams |
|---|---|
| Glyphosate dry powder (95%) | 432.0 |
| Silwet ® 408 | 5.0 |
| Lactose | 563.0 |

Mixing the above ingredients by the indicated ratios and following the steps in Example 1, water-dispersible granules containing active ingredient of 410 g/kg glyphosate are obtained.

### Example 3

### Preparing Water-Dispersible Granules Containing Active Ingredient of 500 g/kg Glyphosate

Pre-mixture of water-dispersible granules containing 500 g/kg
glyphosate

| Composition | Grams |
|---|---|
| Glyphosate dry powder (95%) | 527.0 |
| Silwet ® 408 | 30.0 |
| Sucrose | 373.0 |
| Maltodextrin | 70.0 |

Mixing the above ingredients by the indicated ratios and following the steps in Example 1, water-dispersible granules containing active ingredient of 500 g/kg glyphosate are obtained.

### Example 4

### Preparing Water-Dispersible Granules Containing Active Ingredient of 600 g/kg Glyphosate

Pre-mixture of water-dispersible granules containing 600 g/kg
glyphosate

| Composition | Grams |
|---|---|
| Glyphosate dry powder (95%) | 632.0 |
| Silwet ® 408 | 20.0 |
| Sucrose | 348.0 |

Mixing the above ingredients by the indicated ratios and following the steps in Example 1, water-dispersible granules containing active ingredient of 600 g/kg glyphosate are obtained.

### Example 5

### Preparing Water-Dispersible Granules Containing Active Ingredient of 747 g/kg Glyphosate

Pre-mixture of water-dispersible granules containing 747 g/kg
glyphosate

| Composition | Grams |
|---|---|
| Glyphosate dry powder (95%) | 787.0 |
| Silwet ® L-77 | 50.0 |
| Sucrose | 163.0 |

Silwet ® L-77 is an adjuvant

Mixing the above ingredients by the indicated ratios and following the steps in Example 1, water-dispersible granules containing active ingredient of 747 g/kg glyphosate are obtained.

### Example 6

### Preparing Water-Dispersible Granules Containing Active Ingredient of 720 g/kg Glyphosate

Pre-mixture of water-dispersible granules containing 720 g/kg
glyphosate

| Composition | Grams |
|---|---|
| Glyphosate dry powder (95%) | 758.0 |
| Silwet ® 408 | 10.0 |
| Sucrose | 162.0 |
| Maltodextrin | 70.0 |

Mixing the above ingredients by the indicated ratios and following the steps in Example 1, water-dispersible granules containing active ingredient of 720 g/kg glyphosate are obtained.

### Example 7

### Preparing Water-Dispersible Granules Containing Active Ingredient of 720 g/kg Glyphosate

Pre-mixture of water-dispersible granules containing 720 g/kg
glyphosate

| Composition | Grams |
|---|---|
| Glyphosate dry powder (95%) | 758.0 |
| Silwet ® 408 | 30.0 |
| Maltodextrin | 70.0 |
| Sucrose | 142.0 |

Mixing the above ingredients by the indicated ratios and following the steps in Example 1, water-dispersible granules containing active ingredient of 720 g/kg glyphosate are obtained.

### Example 8

### Preparing Water-Dispersible Granules Containing Active Ingredient of 720 g/kg Glyphosate

Pre-mixture of water-dispersible granules containing 720 g/kg
glyphosate

| Composition | Grams |
|---|---|
| Glyphosate dry powder (95%) | 758.0 |
| Silwet ® 408 | 50.0 |
| Maltodextrin | 70.0 |
| Sucrose | 122.0 |

Mixing the above ingredients by the indicated ratios and following the steps in Example 1, water-dispersible granules containing active ingredient of 720 g/kg glyphosate are obtained.

### Example 9

### Preparing Water-Dispersible Granules Containing Active Ingredient of 747 g/kg Glyphosate

Pre-mixture of water-dispersible granules containing 747 g/kg
glyphosate

| Composition | Grams |
|---|---|
| Glyphosate dry powder (95%) | 787.0 |
| Silwet ® 408 | 40.0 |
| Maltodextrin | 20.0 |
| Sucrose | 153.0 |

Mixing the above ingredients by the indicated ratios and following the steps in Example 1, water-dispersible granules containing active ingredient of 747 g/kg glyphosate are obtained.

### Example 10

### Preparing Water-Dispersible Granules Containing Active Ingredient of 910 g/kg Glyphosate

Pre-mixture of water-dispersible granules containing 910 g/kg
glyphosate

| Composition | Grams |
|---|---|
| Glyphosate dry powder (95%) | 958.0 |
| Silwet ® 806 | 30.0 |
| Sucrose | 12.0 |

Silwet ® 806 is an adjuvant

Mixing the above ingredients by the indicated ratios and following the steps in Example 1, water-dispersible granules containing active ingredient of 910 g/kg glyphosate are obtained.

### FIELD TEST

Field test was carried out to compare the weed control effect of finished products (water-dispersible granules containing 720 g/kg glyphosate) prepared in Examples 6, 7 and 8 with products available on the market.

A. Materials and Method

Divide the test area into eighteen 5 m×2 m (10 m²) blocks. Apply the test material to fast growing and flowering stage weeds (see Table 1 for test materials) on non-farming land (3 blocks per treatment). Arrange the treatment blocks in randomized complete block design (RCBD). Prior to application, observe the weed canopy, and species and names of weeds in the test area (Table 2).

B. Evaluation Standards

Examine visually the percentage of weed yellowing in each treatment block on day 7, day 14, day 21 and day 27 after application; compare the test data using Duncan's Multiple Range Test at 5% significance level.

Weed control rate: evaluate the effect on 3˜5 major weeds by visual observation (e.g. drying, dwarfing, inhibited growth, number of weeds, weight of weed), and express the results by percentage.

TABLE 1
Dose of Water-dispersible Granules of 720 g/kg Glyphosate Acid (GA) and
Dose of Active Ingredient in the Field Test

| | | | | Dose of active | |
|---|---|---|---|---|---|
| | | | Dose per block | ingredient/hectare | Dose/hectare |
| No. | Sample | Formulation | (g or ml) | (g or ml) | (kg or L) |
| 1 | Blank control | NA | 0 | 0 | 0 |
| 2 | 720 g/kg GA | Water-dispersible | 2.53 | 1822 | 2.53 |
| | (Example 6) | granule | | | |
| 3 | 720 g/kg GA | Water-dispersible | 2.53 | 1822 | 2.53 |
| | (Example 7) | granule | | | |
| 4 | 720 g/kg GA | Water-dispersible | 2.53 | 1822 | 2.53 |
| | (Example 8) | granule | | | |
| 5 | 410 g/kg glyphosate | Liquid | 6.00 | 1822 | 6.00 |
| | isopropylammonium | | | | |
| | salt (liquid), as 303.8 g/kg | | | | |
| | GA | | | | |
| 6 | 747 g/kg Glyphosate | Water-soluble granule | 2.68 | 1822 | 2.68 |
| | ammonium (water- | | | | |
| | soluble granule, | | | | |
| | market brand), as | | | | |
| | 678.8 g/kg GA | | | | |

Group 1 was blank control; Groups 2, 3, and 4 used the formulation of this invention; Group 5 was a liquid formulation control; Groups 6 was water-soluble granules of another brand. The results of field test are illustrated in Table 3 below.

TABLE 2
Major Weed Species and Canopy (%) of Test Area before
Application of Herbicide

| | Group No. | | | | | | |
|---|---|---|---|---|---|---|---|
| Weed species | 1 | 2 | 3 | 4 | 5 | 6 | Remark |
| Southern crabgrass | 53.1 | 59.0 | 58.5 | 57.3 | 55.3 | 57.8 | |
| (Digitaria | | | | | | | |
| adscendens) | | | | | | | |
| Bermudagrass | 45.2 | 39.5 | 56.6 | 40.7 | 42.9 | 40.5 | |
| (Cynodon dactylon) | | | | | | | |
| Purple nutgrass | 1.7 | 1.5 | 1.9 | 2.0 | 1.8 | 1.7 | |
| (Cyperus rotundus) | | | | | | | |
| Percentage of total | 100 | 100 | 100 | 100 | 100 | 100 | |
| canopy | | | | | | | |

TABLE 3
Change of Percentage of Yellowing (%)

| | | | Dose/hectare | Days after application | | | |
|---|---|---|---|---|---|---|---|
| No. | Sample | Formulation | D (kg, L/ha) | 7 | 14 | 21 | 27 |
| 1 | Blank control | NA | 0 | 0b | 0b | 0b | 0b |
| 2 | 720 g/kg GA | Water- | 2.53 | 40.8a | 66.4a | 86.2a | 97.5a |
| | (Example 6) | dispersible | | | | | |
| | | granule | | | | | |
| 3 | 720 g/kg GA | Water- | 2.53 | 44.8a | 69.0a | 87.7a | 97.7a |
| | (Example 7) | dispersible | | | | | |
| | | granule | | | | | |
| 4 | 720 g/kg GA | Water- | 2.53 | 45.4a | 70.5a | 88.7a | 99.8a |
| | (Example 8) | dispersible | | | | | |
| | | granule | | | | | |
| 5 | 410 g/kg glyphosate | Liquid | 6.00 | 45.1a | 68.8a | 86.7a | 97.4a |
| | isopropylammonium | | | | | | |
| | salt (liquid), as 303.8 | | | | | | |
| | g/kg GA | | | | | | |
| 6 | 747 g/kg Glyphosate | Water-soluble | 2.68 | 41.2a | 67.1a | 85.7a | 96.7a |
| | ammonium (water- | granule | | | | | |
| | soluble granule, | | | | | | |
| | market brand), as | | | | | | |
| | 678.8 g/kg GA | | | | | | |

*Statistical analysis used Duncan's Multiple Range Test at 5% significance level; a and b indicate significant difference between treatment blocks.

C. Results
1. Test Time

Test materials were applied to treatment blocks on Mar. 24, 2005.

2. Species of Weed

Weeds in the test area included: 1. southern crabgrass, 2. bermudagrass, 3. purple nutgrass.

3. First Observation After Application

Treatment blocks were observed on Mar. 31, 2005 (day 7 after application) and no significant difference among different groups was found based on Duncan's multiple range test, indicating that the herbicide according to the present invention had good preliminary result.

4. The second and third observations after application

In subsequent observations taken place on Apr. 7, 2005 and Apr. 14, 2005 (day 14 and day 21 after application), the percentage of yellowing in each treatment block was close without significant difference.

5. The Fourth Observation After Application

In the final observation conducted on Apr. 20, 2005 (day 27 after application), yellowing in each treatment block was close to 100%, of which Group 4 displayed the best weed control effect with 99.8% yellowing.

D. Conclusion

The results of the field test above indicate that the simplified formulation and process disclosed in the present invention provide the same or better effect as compared to liquid and water-soluble granular products available on the market, while offering the advantages of cost saving by using glyphosate in its original form; and moreover, not cause acidification and salination of soil by using non-inorganic salt extender.

What is claimed is:

1. A herbicide composition, comprising:
50˜950 g/kg glyphosate;
5˜950 g/kg non-inorganic salt extender; and
0.5˜150 g/kg organo-silicon surfactant.

2. The herbicide composition of claim 1, wherein said glyphosate is not a salt derivative.

3. The herbicide composition of claim 1, wherein the content of said glyphosate is 100˜920 g/kg.

4. The herbicide composition of claim 1, wherein the content of said organo-surfactant is 1˜100 g/kg.

5. The herbicide composition of claim 1, wherein said organo-surfactant is a polyalkene oxide modified heptamethyl trisiloxane compound or combinations thereof.

6. The herbicide composition of claim 1, wherein said organo-surfactant is an extrusion aid.

7. The herbicide composition of claim 1, wherein said content of extender is 10˜946 g/kg.

8. The herbicide composition of claim 1, wherein said extender is a water-soluble non-inorganic salt.

9. The herbicide composition of claim 1, further comprises a synergistic herbicide.

10. The herbicide composition of claim 1, wherein said synergistic herbicide is selected from the group consisting of: 2,4-D (2,4-dichlorophenoxy acetic acid), 2,4,5-T (2,4,5-trichloroacetic acid), 2,3,6-TBA (2,3,6-trichlorobenzoic acid), amidosulfuron, acifluorfen-sodium, bilanafos, chloramben, dalapon, dicamba(3,6-dichloro-O-anisic acid), dichlorprop, endothal, glufosinate, mecoprop, MCPA, MCPB, picloram, imazaquin and combination thereof.

11. The herbicide composition of claim 1, wherein said extender includes lactose, sucrose, glucose, dextrin, cyclodextrin, maltodextrin or combination thereof.

12. The herbicide composition of claim 1, wherein the herbicide composition is dried granule.

13. The herbicide composition of claim 1, wherein the herbicide composition is further mixed with other herbicide, insecticide, dustmite miticide, nematicide, fungicide, or plant growth regulator.

14. A method for preparing herbicide composition, comprising the steps of:
(a) mixing glyphosate, extender, and organo-surfactant to form a pre-mixture;
(b) milling said pre-mixture into finer powdesr with at least 50% of powders having grain diameter smaller than 0.075 mm;
(c) adding 30˜200 g/kg of water to mix with said finer powders;
(d) extruding mixture resulted in step (c) to obtain herbicide composition in granular shape; and
(e) drying the herbicide composition obtained in step (d) to remove moisture.

15. The method of claim 14, wherein mixing ratios of said glyphosate, extender, and organo-surfactant are: 50˜950 g/kg glyphosate; 5˜950 g/kg non-inorganic salt extender; and 0.5˜150 g/kg organo-silicon surfactant.

16. The method of claim 14, wherein mixing ratios of said glyphosate, extender, and organo-surfactant are: 100˜920 g/kg glyphosate; 10˜946 g/kg non-inorganic salt extender; and 1˜100 g/kg organo-silicon surfactant.

17. The method of claim 14, wherein said glyphosate in step (a) is not a salt derivative.

18. The method of claim 14, wherein at least 90% of said finer powders in step (b) has grain diameter less than 0.075 mm.

19. The method of claim 14, wherein the amount of said water added in step (c) is 50˜140 g/kg.

20. The method of claim 14, wherein said extrusion in step (d) is conducted in a extruder.

21. The method of claim 14, wherein the moisture content in the finished product of said herbicide composition after drying is 0.1˜60 g/kg.

22. The method of claim 14, wherein the moisture content in the finished product of said herbicide composition after drying is 1˜35 g/kg.

23. The method of claim 14, wherein said drying step in step (c) is carried out in a fluid bed dryer or an oven.

24. The method of claim 14, wherein said organo-surfactant is a polyalkene oxide modified heptamethyl trisiloxane compound or combinations thereof.
